(19) United States
(12) Patent Application Publication
(10) Pub. No.: US 2006/0203764 A1
(43) Pub. Date: Sep. 14, 2006

(54) Delay-based cell portion selection

(75) Inventor: Klaus Hugl, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/129,473

(22) Filed: May 16, 2005

(30) Foreign Application Priority Data
Mar. 11, 2005 (EP) 05005407.1

(51) Int. Cl. H04J 3/06; H04Q 7/24; H04Q 7/00

(52) U.S. Cl. 370/328; 370/338; 370/503

(57) ABSTRACT

The present invention relates to a method and network device for identifying a cell portion to be selected from at least two cell portions each served by at least one respective remote head, wherein respective cell-portion specific amounts of delay are allocated to each of said at least two cell portions and signals received from said at least two cell portions are delayed by the cell-portion specific amounts of delay. Cell-portion specific signals can then be separated based on their time of occurrence. Thereby, a separation in the delay domain is possible during uplink reception in order to distinguish between different cell portions to which downlink signals can then be selectively transmitted. The downlink capacity can thus be increased without requiring increase of uplink capacity and complexity at the same time.

### FIELD OF THE INVENTION

The present invention relates to a method and apparatus for identifying a cell portion to be selected from at least two cell portions served by at least one respective remote head of a distributed base station device, such as a Node B of an UTRAN (Universal Mobile Communications System Terrestrial Radio Access Network).

### BACKGROUND OF THE INVENTION

With indoor coverage increasingly becoming a differentiator in office parks, shopping malls, tunnels and sports arenas, advanced indoor radio solutions have been developed in combination with high speed downlink transmission for support of bandwidth-intensive services such as video.

One of the features of such improved systems is a distributed base station concept (D-BTS) where a more selective transmission is achieved by using several remote heads connected to a base station device (e.g. Node B in UTRAN). The signals from the remote heads are combined at the base station device and processed in a transceiver baseband unit. As a result of the processing of a single stream in uplink and downlink, low baseband complexity can be achieved. Additionally, coverage can be improved due to the plurality of remote heads used for wireless transmission.

However, the proposed distributed base station concepts suffer from the problem of low capacity due to increased interference in uplink and shared downlink transmission power of all terminal devices or user equipments (UEs) connected wirelessly. Scenarios were created on how to meet increased capacity demands. As an example, a distributed base station concept with group-wise combining and transmission has been suggested in which cell portions comprising one or more remote heads operate in principle independently. Identification can be based on e.g. the Secondary Common Pilot Channel (S-CPICH) of WCDMA (Wireless Code Division Multiple Access) systems and cell-portion specific uplink measurements. Different cells can be discriminated based on a different Primary Common Pilot Channel (P-CPICH), scrambling code etc. and soft handover can be performed by the radio network controller (RNC). These concepts however lead to the disadvantage that increased downlink capacity is automatically accompanied by a necessary similar upgrade in uplink capacity, operation and complexity.

### SUMMARY OF THE INVENTION

It is therefore an object of the present invention to provide an improved distributed base station architecture in which downlink capacity can be upgraded or enhanced while keeping uplink complexity and hardware requirements within reasonable limits.

This object is achieved by a method of identifying a cell portion to be selected from at least two cell portions each served by at least one respective remote head of a distributed base station device, said method comprising the steps of:
allocating respective cell-portion specific amounts of delay to each of said at least two cell portions;
delaying signals received from said at least two cell portions by the respective cell-portion specific amounts of delay; and
separating cell-portion specific signals based on their time of occurrence.

Furthermore, the above object is achieved by a network device for identifying a cell portion to be selected from at least two cell portions each served by at least one respective remote head of a distributed base station device, said network device comprising:
delay means for adding a respective cell-portion specific amount of delay to a signal received from said at least two cell portions;
combining means for combining signals received from said at least two cell portions after subjection to said cell-portion specific amount of delay; and
separating means for separating cell-portion specific signals based on their time of occurrence.

Accordingly, uplink signals can be processed as a single signal stream at less complexity and capacity requirements. The received signals from the cell portions can be separated based on their time of occurrence. If the uplink capacity is still sufficient to serve all users with reasonable quality, only the downlink capacity can be increased in cases of unbalanced traffic in uplink and downlink directions. Low uplink complexity with relatively low uplink capacity can thus be combined with enhanced downlink capacity and complexity. An automatic increase of uplink processing complexity and capacity is no longer needed.

Based on the separated cell-portion specific signals, cell-portion specific signal quality measurements may be derived to be used for cell-portion transmission selection.

The allocating step may comprise allocating a zero amount of delay to a first cell portion and a non-zero amount of delay to a second cell portion. This means that the delay can be introduced only to some of the reception lines from the remote heads to thereby further reduce complexity. In systems with only two cell portions per distributed base station, the signals of one cell portion can be processed without any delay, while the signals of the other cell portions are delayed. The cell-portion specific amounts of delay should be set longer than propagation delay differences which result from different path lengths between the remote heads and served mobile terminals. Thereby, separation of the cell-portion specific signals can be assured.

Using the proposed delay-based identification, downlink signals can be selectively transmitted to a cell portion selected based on an information obtained from the separated received signal. This information may comprise a result of a cell-portion specific signal quality measurement, such as a SIR (Signal-to-Interference Ratio) measurement. This information can be reported to a radio network controller device which controls the selection of downlink transmission paths.

The separating step may comprise a filtering step in the delay domain based on an estimated channel impulse response. As an example, the filtering step may be achieved by using a rectangular filter function which corresponds to a delay window.

The delay means may comprise a delay element inserted into cell-portion specific reception lines of the network device. This delay element can be inserted prior to the combining means.

Furthermore, the combining means may be configured to combine all cell-portion specific signals into a single uplink signal. Thereby, minimum complexity is added in the uplink direction.

The proposed solution can be implemented as a software feature for distributed base station devices. Thus, implementation can be achieved in the form of a computer program product device comprising code means for producing the above method steps when run on a computer device, e.g. a base station device.

Of course, the functional components of the above solution may as well be implemented as hardware units in a fixedly wired solution.

### BRIEF DESCRIPTION OF THE DRAWINGS

In the following, the present invention will be described in greater detail based on a preferred embodiment with reference to the accompanying drawings in which:

FIG. 1 shows a schematic block diagram of a distributed base station device according to the preferred embodiment;

FIG. 2 shows diagrams indicating channel estimates for different user equipments received through several remote heads;

FIG. 3 shows a diagram indicating SIR estimations for a specific user equipment using cell-portion specific delay windows;

FIG. 4 shows a schematic block diagram of a first example of the baseband receiving unit according to the preferred embodiment; and

FIG. 5 shows a schematic block diagram of a second example of the baseband receiving unit according to the preferred embodiment.

### DESCRIPTION OF THE PREFERRED EMBODIMENT

The preferred embodiment will now be described on the basis of a distributed base station concept in a UTRAN environment.

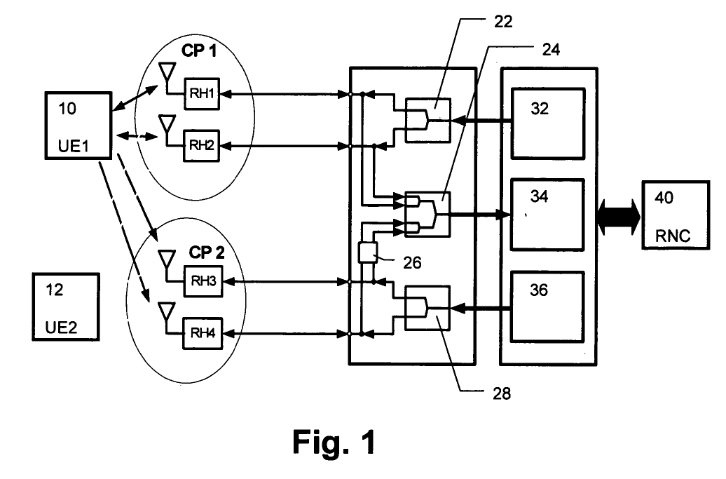

FIG. 1 shows a schematic block diagram of the first preferred embodiment, wherein a first UE 10 and a second UE 12 are connected with respective antennas of remote heads RH1 to RH4 of respective cell portions CP1 and CP2 to a splitter/combiner architecture of the distributed base station or Node B. The splitter/combiner architecture comprises two downlink splitters 22, 28, one allocated to the first cell portion CP1 with its remote heads RH1 and RH2 and the other allocated to the second cell portion CP2 with its remote heads RH3 and RH4. Thereby, an improved capacity is achieved in the downlink direction due to the fact that the two cell portions CP1 and CP2 are individually supplied by dedicated transmission signals. In the uplink direction a common combiner 24 is provided which combines all four signals received from all remote heads RH1 to RH4 of both cell portions CP1 and CP2. Thereby, a single uplink stream is provided.

The two downlink splitters 22, 28 and the single uplink combiner 24 may be implemented as logical and digital circuits in the baseband domain for splitting or respectively combining the baseband signals received from the remote heads RH1 to RH4. Down-conversion from the radio frequency range is thus performed at the remote heads RH1 to RH4.

The splitting/combining architecture is connected to a baseband unit of the distributed base station device, which comprises a first downlink transmission unit 32 allocated to the first cell portion CP1 and a second downlink transmission unit 36 allocated to the second cell portion CP2. Furthermore, the baseband unit comprises an uplink receiving unit 34 to which the combined single uplink stream is supplied. The baseband unit is connected via network lines to a network controller (RNC) 40 of the UTRAN.

In case of an analog remote head interface, the two downlink splitters 22, 28 and the single uplink combiner 24 may be implemented as analog components in the radio frequency domain for splitting or respectively combining the baseband signals received from the remote heads RH1 to RH4. In this case, the downconversion from the radio frequency range to baseband is thus additionally performed in the uplink receiving unit 34. Moreover, the downlink transmission units 32 and 36 then also have to include the up-conversion to the radio frequency range in addition to the above explained baseband functionalities for CP1 and CP2.

In the uplink connection lines from the remote heads RH3 and RH4 of the second cell portion CP2, a delay element 26 is inserted before the uplink combiner 24 so that the signals received from the second cell portion CP2 are delayed by a predetermined amount of delay. Thereby, these signals are delayed with respect to the non-delayed signals received from the first cell portion CP1. Due to the fact that a common frame scheme is used for all uplink signals, the dedicated delay in the delay element 26 enables separation of uplink reception signals in the delay domain in order to distinguish between the different cell portions CP1 and CP2, so that selective transmission in the downlink direction is enabled. By applying some kind of filtering in the delay domain based on e.g. estimated channel impulse responses obtained at the uplink receiving unit 34, it is possible to measure a cell-portion specific SIR value as defined for example in the 3GPP (3^{rd} Generation Partnership Project) specification TS 25.215 V5.5.0. These quality measurement results are reported to the RNC 40. It is noted that such measurements do not significantly enhance complexity due to the fact that they have already been included in standard devices to support fixed beam forming operation in WCDMA systems.

Based on this quality measurement information, the RNC40 can select the best cell portion for transmission. Thereby, user specific information can be transmitted selectively through selected remote units or remote heads of the selected cell portion and not through all remote heads as in case of the initially described conventional distributed antenna concepts. Thereby, transmission power can be saved and downlink capacity is increased automatically.

Due to the fact that only a single uplink reception stream is processed in the distributed base station device, only a single searcher is needed for several cell portions, so that cell-portion specific searchers can dispensed with. In this way, uplink baseband hardware can be saved and cell-portion specific transmission enhancing downlink capacity can still be provided with only small increase in uplink processing complexity. The moderate increase results from several signal quality measurements in the single uplink signal stream processed at the uplink reception unit 34.

As can be gathered from FIG. 1, two remote heads build one cell portion with independent downlink transmission in the preferred embodiment. In uplink reception, the signals transmitted from the UEs 10, 12 are received by all remote heads RH1 to RH4 and are converted into digital baseband signals, which are “hard-combined” at the uplink combiner unit 24 after insertion of the cell-portion specific delay TCP for the second cell portion CP2 at the delay element 26. In the digital baseband environment, the delay element may be achieved by known digital delay elements such as latch circuits, flip flop devices, register circuits or the like. In case of an analog radio frequency range interface, the delay can be realized by an analog delay element such as delay lines.

The cell-portion specific delay allows cell portion identification and cell-portion specific signal quality measurements, e.g. SIR measurements, at the uplink receiving unit 34, which are reported to the RNC 40. The received uplink signals use a slot structure with several slots forming a radio frame. Each slot has predetermined fields for pilot bits, which are used for channel estimation in the baseband receiving unit 34. Thus, for every slot, channel estimates are obtained from the pilot bits and a SIR or another quality measurement can be performed.

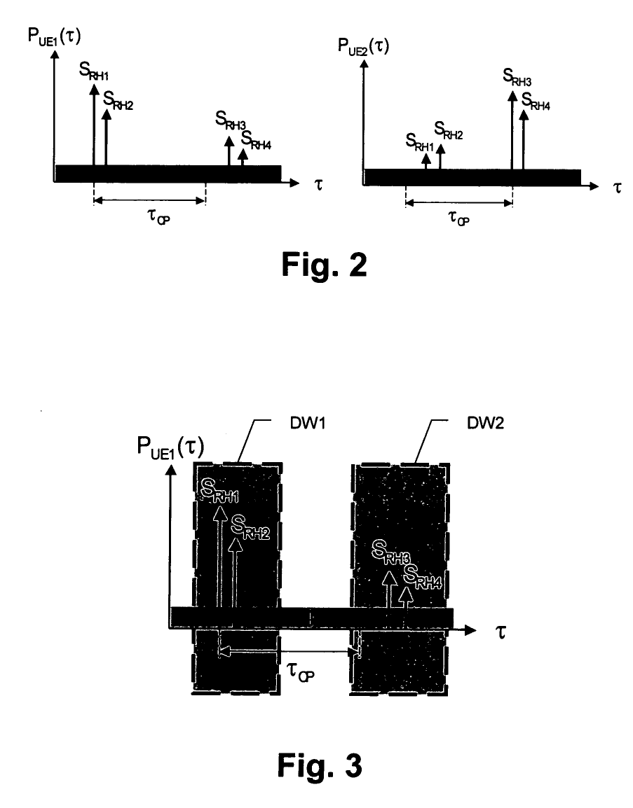

FIG. 2 shows two diagrams indicating received signal powers P_{UE1} and P_{UE2} in dependence on the signal delay T. The arrows S_{RH1}, S_{RH2}, S_{RH3} and S_{RH4} indicate values of channel estimates for the signals of the respective UE as received by the four remote heads RH1 to RH4. In general, the value S_{RHx} denotes the signal contribution received through the x-th remote head.

From the left diagram of FIG. 2 it can be gathered that the first UE (UE1) 10 is located closer to the first cell portion CP1 so that the channel estimates of the two remote heads RH1 and RH2 of the first cell portion CP1 are larger. On the other hand, the right-hand diagram, which relates to the signals of the second UE (UE2) 12, indicates that the second UE 12 is located closer to the second cell portion CP2 and thus produces larger channel estimates S_{RH3} and S_{RH4} at the remote heads RH3 and RH4 of the second cell portion CP2. The grey or shaded level in the diagram indicates the interference level of the received signals.

As can be seen from FIG. 2 a separation of the signals received through the remote heads RH3 and RH4 (CP2) from the signals received through the remote heads RH1 and RH2 (CP1) is possible in the delay domain due to the cell-portion specific inserted delay τ_{cp} at or before the uplink signal combiner 24 of FIG. 1. Preferably, the cell-portion specific inserted delay τ_{CP} should be larger than the propagation delay differences due to the different path lengths between the UEs and the different remote heads.

FIG. 3 shows another diagram indicating signal power vs. delay, wherein delay windows DW1 and DW2 are introduced to separate uplink signal streams for the first cell portion CP1 and the second cell portion CP2 for the case of the first UE (UE1) 10. Thereby, cell-portion specific uplink SIR measurements can be performed for the RNC 40 even in the present case where the signals from the remote heads RH1 to RH4 are not received cell-portion specific, i.e. no separate uplink signal streams are provided for the first cell portion CP1 and the second cell portion CP2.

The delay windows DW1 and DW2 can be achieved by introducing a rectangular filter function in the delay domain, so that the cell-portion specific signals can easily be separated. This could be understood as a “beam forming in the delay domain” to express it in analogy to the fixed beam concept, which cell specific measurements have originally been designed for. The filtering function can be based on any known window processing or gating of signals in the digital domain. Thus, signal quality is estimated inside the delay window DW1 for the first cell portion CP1 to obtain the uplink SIR for the first cell portion CP1, and in the same way in the second delay window DW2 for the second cell portion CP2. These two quantities or measurement results are then reported to the RNC 40 which decides on the downlink transmission assignment of the different UEs 10, 12 to the different cell portions CP1 and CP2.

In the present example, the RNC 40 will assign the first UE 10 to the first cell portion CP1 and the second UE 12 to the second cell portion CP2 due to the respective higher SIR measurement values. As a consequence, the downlink signals for the first UE 10 will only be transmitted through the first cell portion CP1 (RH1 and RH2) as indicated by the arrows in FIG. 1, and the downlink signals for the second UE 12 are only transmitted through the second cell portion CP2 (RH3 and RH4). To achieve this, the RNC 40 informs the respective UE which S-CPICH (which is then cell-portion specific) to use for channel estimation. This way, the UE is able to decode the information transmitted from the specific cell portion.

In the following, two examples for implementation of the cell-portion specific quality measurement and reporting function are described as a part of the uplink receiver unit 34. The basic issue is about how the signal quality measures that are needed for transmitter selection can or are being derived. According to the preferred embodiment, quality measurements are obtained independently for each cell portion with the help of the delays.

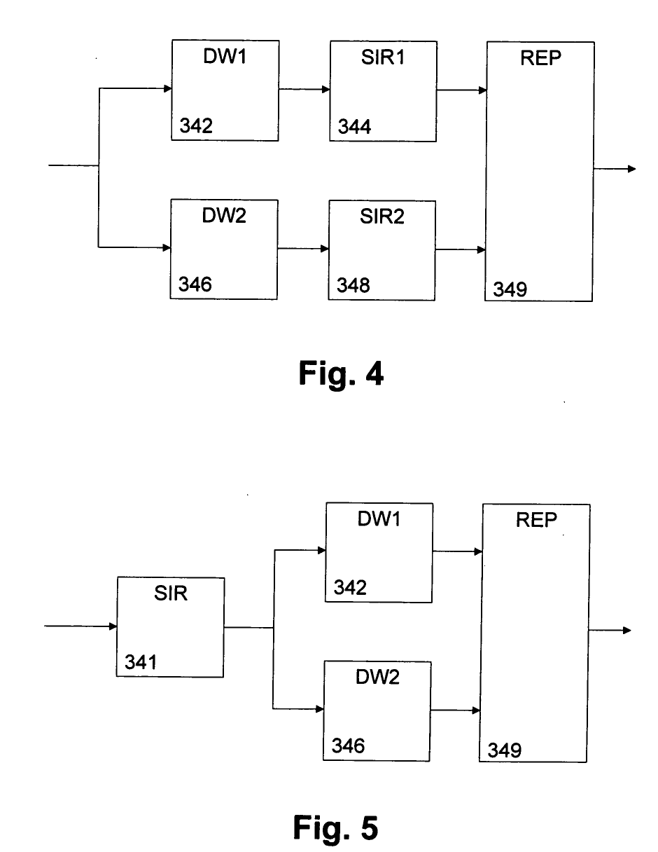

FIG. 4 shows a schematic block diagram of a first example for implementation of the cell-portion specific quality measurement and reporting function as a part of the uplink receiver unit 34. In the first example, filtering is done before the quality measurement. According to FIG. 4, the combined uplink stream comprising the individual signals with cell-portion specific delay are supplied to first and second filtering units 342, 346 in which a rectangular filter processing is applied according to the first and second delay windows DW1 and DW2, respectively. Thereby, the received signals of the first and second cell portions CP1 and CP2 are separated. In the upper branch, the separated cell-portion specific uplink signal is supplied to a first quality measuring unit 344 in which an SIR measurement is performed e.g. based on the pilot bits. Similarly, in the lower branch, the separated signal received from the second cell portion CP2 is supplied to a second quality measuring unit 348 in which a second SIR measurement is performed. The measuring results obtained from the upper and lower branch are supplied to a reporting unit or function 349 in which a corresponding report signal is generated and transmitted to the RNC40.

The filtering unit 342 and 346 as well as the quality measurement unit 344 and 348 and the reporting unit 349 can be implemented as software routines used for controlling a corresponding processor device of the distributed base station device, or may be alternatively implemented as concrete hardware units. The same applies to the delay element 26 which may as well be implemented based on a software routine.

FIG. 5 shows a schematic block diagram of a second example for implementation of the cell-portion specific quality measurement and reporting as a part of the uplink receiver unit 34.

In the alternative implementation of the second example, quality measurements are first obtained in a single quality measurement unit 341, e.g., by estimating SIRs of different taps obtained from the received signals and allocating for each of those taps a RAKE finger in the uplink receiver. Thus, the quality measurements (SIRs) for each of the taps from the the remote heads RH1 to RH4, as shown in FIGS. 2 and 3, are already available. The SIR for each of the cell portions can then be obtained by filtering in the time domain the already existent SIR measurements, using the filtering units 342 and 346. This means, in the current uplink baseband, a RAKE finger can be allocated to each of the taps, which have been found. In the present case of FIG. 1, four taps related to four the remote heads RH1 to RH4. For each of the taps, a dedicated SIR is obtained. E.g., for uplink power control, the SIR of the different RAKE fingers can be added up to generate a received SIR on which the uplink power control is based.

According to the present embodiment, additional SIRs are obtained for each cell portion, i.e., by adding the SIRs obtained from the signals (i.e. taps) of the remote heads RH1 and RH2 of the first cell portion CP1 and by adding the SIRs obtained from the signals (i.e. taps) of the remote heads RH3 and RH4 of the second cell portion CP2, as a solution which can be implemented easily. Therein, the identification of the cell portion, the taps are belonging to, is simply done in the delay domain.

Thus, in the second example, the separation in the delay domain is in principle happening after the SIR estimation, while the addition as mentioned above can be regarded as part of the filtering process.

It is noted that the signals or taps do not really have to be separated themselves, but just the measurements needed to provide the quality measurement values for the RNC 40. The signals in other parts of the receiver not really need to be separated, except that allocating a finger and multiplying with the scrambling and channelization codes leads to some kind of separation in the delay domain.

Of course, mere separation of the SIR measurement values can be sufficient if the SIRs of the RAKE fingers of the respective cell-portions are added.

Therefore, using the cell-portion specific delays in the uplink direction, it is possible to operate the distributed base station system with a simple uplink coverage solution where the signals of all remote heads RH1 to RH4 are combine into a single uplink stream, while cell-portion specific transmission is supported in the downlink direction as a kind of “fixed beam forming” operation. Downlink capacity can thus be increased compared to conventional advanced indoor radio applications where downlink transmission is performed via all remote heads. This increased downlink capacity is possible without the requirement of increasing the uplink capacity and complexity at the same time.

It is noted that the present invention is not restricted to the above preferred embodiment but can be applied in connection with any distributed base station concept of any technology, where cell-portion specific remote heads are used for obtaining better coverage. The cell portion selection for downlink transmission can be based on any criteria suitable for discriminating or optimizing cell portions for specific terminal devices. The location of the delay element 26 in FIG. 1 may be changed to delay the signals received from the first cell portion CP1, or even the signals from both cell portions CP1 and CP2 may be delayed by different dedicated delay elements. Moreover, a distributed architecture with more than two cell portions may be implemented, where a specific delay including a zero delay may be allocated to the individual signals received from the cell portions. The preferred embodiment may thus vary within the scope of the attached claims.

1. A method of identifying a cell portion to be selected from at least two cell portions, each served by at least one respective remote head of a distributed base station device, said method comprising the steps of:
a) allocating respective cell-portion specific amounts of delay to each of said two cell portions;
b) delaying signals received from said at least two cell portions by the respective cell-portion specific amounts of delay; and
c) separating cell-portion specific signals based on an associated time of occurrence of each cell-portion specific signal.

2. A method according to claim 1, wherein said allocating step comprises allocating a zero amount of delay to a first cell portion and non-zero amount of delay to a second cell portion.

3. A method according to claim 1, wherein said respective cell-portion specific amounts of delay are set to be larger than propagation delay differences due to different path lengths between said remote heads and served mobile terminals.

4. A method according claim 1, further comprising the step of:
selectively transmitting downlink signals to a cell portion selected based on information obtained from said separated cell-portion specific signals.

5. A method according to claim 4, wherein said information comprises a result of a cell-portion specific quality measurement.

6. A method according to claim 5, wherein said quality measurement comprises an SIR measurement.

7. A method according to claim 1, wherein said cell-portion specific signals comprise cell-portion specific quality measurements.

8. A method according to claim 4, wherein said information is reported to a radio network controller device.

9. A method according to claim 1, wherein said separating step comprises a filtering step in a delay domain based on an estimated channel impulse response.

10. A method according to claim 9, wherein said filtering step is achieved by using a rectangular filter function, which corresponds to a delay window.

11. A network device for identifying a cell portion to be selected from at least two cell portions, each served by at least one respective remote head, said network device comprising:
a) delay means for adding a respective cell-portion specific amount of delay to a signal received from said at least two cell portions;
b) combining means for combining signals received from said at least two cell portions after subjecting each signal to said cell-portion specific amount of delay; and
c) separating means for separating cell-portion specific signals based on an associated time of occurrence of each cell-portion specific signal.

12. A network device according to claim 11, wherein said delay means comprise a delay element inserted into cell-portion specific reception lines of said network device.

13. A network device according to claim 12, wherein said delay element is inserted prior to said combining means.

14. A network device according to claim 11, wherein said combining means is configured to combine all cell-portion specific signals into a single uplink signal.

15. A network device according to claim 11, wherein said separating means comprises filtering means for filtering said cell-portion specific signal in a delay domain.

16. A network device according to claim 11, further comprising:
quality measuring means for measuring a cell-portion specific signal quality.

17. A network device according to claim 16, further comprising:
reporting means for reporting said cell-portion specific signal quality to a radio network controller device.

18. A network device according to claim 11, wherein said network device is a distributed base station device.

19. A base station device for identifying a cell portion to be selected from at least two cell portions, each served by at least one respective remote head, said network device comprising:
a) delay means for adding a respective cell-portion specific amount of delay to a signal received from said at least two cell portions;
b) combining means for combining signals received from said at least two cell portions after subjecting each signal to said cell-portion specific amount of delay; and
c) separating means for separating cell-portion specific signals based on an associated time of occurrence of each cell-portion specific signal.

20. A network device for identifying a cell portion to be selected from at least two cell portions, each served by at least one respective remote head, said network device comprising:
a) a delay element for adding a respective cell-portion specific amount of delay to a signal received from said at least two cell portions;
b) a combiner for combining signals received from said at least two cell portions after subjecting each signal to said cell-portion specific amount of delay; and
c) a receiving unit for separating cell-portion specific signals based on an associated time of occurrence of each cell-portion specific signal.

21. A computer program embodied on a computer readable medium, the computer program being configured to perform the steps of:
identifying a cell portion to be selected from at least two cell portions, each served by at least one respective remote head of a distributed base station device;
allocating respective cell-portion specific amounts of delay to each of said two cell portions;
delaying signals received from said at least two cell portions by the respective cell-portion specific amounts of delay; and
separating cell-portion specific signals based on an associated time of occurrence of each cell-portion specific signal.
